(19) United States
(12) Patent Application Publication
(10) Pub. No.: US 2021/0221197 A1
(43) Pub. Date: Jul. 22, 2021

(54) HEATING ELEMENT ASSEMBLY FOR A HEATING DEVICE OF A VEHICLE

(71) Applicant: Mahle International GmbH, Stuttgart (DE)

(72) Inventors: Falk Viehrig, Stuttgart (DE); Robin Wanke, Stuttgart (DE)

(21) Appl. No.: 17/152,783

(22) Filed: Jan. 19, 2021

(30) Foreign Application Priority Data
Jan. 20, 2020 (DE) 10 2020 200 592.3

(51) Int. Cl. B60H 1/22

(52) U.S. Cl. CPC B60H 1/2225; B60H 1/2221

(57) ABSTRACT

A heating element assembly for a heating device of a vehicle may include at least one first PTC heating element configured to heat a fluid, at least one second PTC heating element configured to heat the fluid, and at least one additional heating device configured to heat the at least one first PTC heating element and the at least one second PTC heating element. The at least one first PTC heating element and the at least one second PTC heating element may be arranged spaced apart from one another. The at least one additional heating device may be arranged, at least in sections, between the at least one first PTC heating element and the at least one second PTC heating element.

### CROSS-REFERENCE TO RELATED APPLICATIONS

This application claims priority to German Patent Application No. DE 10 2020 200 592.3, filed on Jan. 20, 2020, the contents of which is hereby incorporated by reference in its entirety.

### TECHNICAL FIELD

The present invention relates to a heating element assembly for a heating device of a vehicle. The invention, furthermore, relates to a heating element register for a heating device of a vehicle and to a heating device for a vehicle. The invention, furthermore, relates to a method for operating a heating device.

### BACKGROUND

Such heating element assemblies typically comprise PTC heating elements in order to convert electric power into heat, in order to provide for example an air conditioning and/or temperature regulation of a passenger compartment in low vehicle outside temperatures.

PTC heating elements are electrically operated heating elements which are supplied with a constant operating voltage. PTC heating elements have a non-linear relationship between the electrical resistance of the PTC heating element and the operating temperature of the PTC heating element, which can be described by a characteristic resistance curve. This characteristic resistance curve exhibits a minimal electrical resistance at a certain limit temperature. At operating temperatures of the PTC heating element above the limit temperature, the electrical resistance of the PTC heating element rises non-linearly and results in a self-regulation of the heating power of the PTC heating element, since through the increased electrical resistance at a constant operating voltage merely a low electric current flows through the PTC heating element. PTC heating elements thus offer the advantage that an additional power regulation and/or temperature regulation, which is required with conventional electrical resistance heating elements, can be done without.

However it is problematic in the known prior art that when a PTC heating element is activated, the operating temperature of the PTC heating element corresponds to the limit temperature at least at times and the electrical resistance of the PTC heating element thus assumes a minimum value. According to Ohm's law it follows from this that at a constant operating voltage the electric current that flows through the PTC heating element assumes a maximum value.

Because of this it is necessary that the entire vehicle electrical system and in particular components of the vehicle electrical system such as conductor tracks, circuit boards, PCB, electrical switching elements, transistors, IGBT, connectors, etc. have to be designed for a peak load which occurs when a PTC heating element is activated and as operating temperature has the limit temperature at least at times.

On the one hand, this results in that for example the costs, in particular the material costs of the electrical system of a vehicle increase since conductor tracks for example have to be selected with a larger cross section and on the other hand electrical switching elements, in particular transistors, have to be employed which are designed for the peak load and thus are more expensive in production or more cost-intensive to buy. On the other hand, the vehicle electrical system consists of a multiplicity of conductor tracks which through the larger cross section also result in an increased weight of the electrical system, in particular of the vehicle.

### SUMMARY

The present invention is based on the object of stating an improved or at least an alternative embodiment of a heating element assembly for a heating device of a vehicle, which in particular with respect to the electric peak load is optimised and/or which makes possible a more cost-effective and/or weight-reduced configuration of an electrical system of a vehicle.

According to the invention, this problem is solved through the subject matter of the independent claim(s). Advantageous embodiments are the subject matter of the dependent claim(s).

The present invention is based on the general idea of heating a PTC heating element via an additional heating device prior to supplying it with an operating voltage, until the PTC heating element has an operating temperature above the limit temperature. By way of this, the electrical peak load that occurs in the electrical system of the vehicle can be reduced.

The heating element assembly according to the invention for a heating device of a vehicle comprises at least one first PTC heating element for heating a fluid and at least one second PTC heating element for heating a fluid. The fluid can be formed for example by a gas flow, in particular an air flow, and/or a liquid flow, in particular a coolant and/or cooling water flow.

A PTC heating element can form an electrically operated heating element, which can be supplied for example with an electric operating voltage, in particular with a constant operating voltage.

A PTC heating element can also be formed as a self-regulating heating element and/or be operated as self-regulating heating element. Here, self-regulating is to mean that the PTC heating element does not exceed a predefined maximum operating temperature without any additional regulating or control device.

A PTC heating element has a non-linear relationship between the electrical resistance of the PTC heating element and the operating temperature of the PTC heating element. This non-linear relationship can be described for example by a characteristic resistance curve of the PTC heating element. This characteristic resistance curve exhibits a minimum electrical resistance at a certain limit temperature.

A PTC heating element can have an NTC operating range and a PTC operating range, wherein the electrical resistance of the PTC heating element in the NTC operating range decreases with increasing operating temperature of the PTC heating element, while the electrical resistance of the PTC heating element in the PTC operating range non-linearly increases with increasing operating temperature of the PTC heating element. The transition point from the NTC operating range to the PTC operating range of the PTC heating element can be defined by the limit temperature, at which the PTC heating element has a minimal electrical resistance.

The abbreviation PTC stands for “positive temperature coefficient”, while the abbreviation NTC stands for “negative temperature coefficient”.

At operating temperatures of the PTC heating element above this limit temperature, i.e. in the PTC operating range, the electrical resistance of the PTC heating element increases non-linearly and results in a self-regulation of the heating power of the PTC heating element, since through the increased electrical resistance merely a low electric current flows through the PTC heating element at a given operating voltage. Thus, PTC heating elements offer the advantage that an additional power regulation and/or temperature regulation, which is required with conventional electrical resistance heating elements, can be dispensed with. Furthermore, the heating element assembly according to the invention comprises at least one additional heating device for heating the first PTC heating element and for heating the second PTC heating element. The additional heating device can be designed as electric additional heating device. The electric additional heating device can be supplied with electric power which, by the additional heating device is converted into heat output and/or heating power.

By heating the PTC heating elements by means of the additional heating device, the PTC heating elements can be transferred into the PTC operating range prior to being supplied with an operating voltage, so that an occurrence of a peak load at the limit temperature can be avoided, since at the time and/or time interval, in which the operating temperature of the PTC heating element corresponds to the limit temperature, no electric current flows through the PTC heating elements. By way of this, the electrical peak load occurring in the vehicle electrical system can be reduced. Furthermore, an elaborate operation of the PTC heating elements by means of pulse width modulation can be omitted by way of this, so that in particular artefacts of a pulse width modulation such as ripple currents for example can be avoided or at least reduced.

The heating power of the additional heating device, in particular of the electric additional heating device, can be designed in such a manner that a heating of the fluid is avoided. By way of this, the self-securing of the PTC heating element can be maintained. The heating power of the additional heating device, in particular of the electric additional heating device, can take place for example via a pulse width modulation of the supplied electric power and/or by an electrical regulation, in particular electrical regulation circuit.

The first PTC heating element and the second PTC heating element are arranged spaced apart from one another, wherein the additional heating device is arranged between the first PTC heating element and the second PTC heating element, at least in sections.

The first PTC heating element and the second PTC heating element can define a heating element pair. It can be provided that an additional heating device is assigned to multiple heating element pairs. The multiple heating element pairs can be arranged spaced apart from one another. Here, the additional heating device can be arranged, at least in sections, between the first PTC heating element and the second PTC heating element of each heating element pair.

The first PTC heating element and the second PTC heating element can be arranged spaced apart from one another with respect to an axial axis, wherein the additional heating device can be arranged, at least in sections, between the first PTC heating element and the second PTC heating element with respect to the axial axis.

The first PTC heating element can comprise a contact surface which faces away from the additional heating device. The first PTC heating element can comprise a surface section which faces the additional heating device. The contact surface and the surface section can form substantially planar and/or flat surfaces, wherein the contact surface and the surface section can be designed so as to be orientated substantially parallel to one another and spaced apart from one another with respect to the axial axis. The axial axis can be orientated substantially parallel to the surface normal vector of the contact surface and of the surface section.

The second PTC heating element can comprise a contact surface which faces away from the additional heating device. The second PTC heating element can comprise a surface section which faces the additional heating device. The contact surface and the surface section can form substantially planar and/or flat surfaces, wherein the contact surface and the surface section can be designed orientated substantially parallel to one another and spaced apart from one another with respect to the axial axis. The axial axis can be orientated substantially parallel to the surface normal vector of the contact surface and of the surface section.

The first PTC heating element, the second PTC heating element and the additional heating device can be arranged, with respect to the axial axis, between two support bodies spaced apart from one another, wherein the support bodies each have a side facing the PTC heating elements, past which a fluid can flow, which can be heated by the PTC heating elements. The first PTC heating element, the second PTC heating element and the additional heating device can be encapsulated by way of the support bodies so as to be fluid-tight relative to the fluid. The support bodies can be formed as support plates, in particular as metallic support plates.

Between the respective contact surface of the PTC heating element and the support body located opposite the contact surface of the PTC heating element, a contact element each can be formed which is connected in an electrically conductive manner with the respective PTC heating element and is electrically insulated relative to the respective support body. Thus, a first contact element can be arranged touchingly lying against the contact surface of the first PTC heating element, wherein a second contact element can be arranged touchingly lying against the contact surface of the second PTC heating element. The first contact element can have a first electrical polarity (e.g. positive pole) and thus form a first electrical pole, wherein the second contact element can have a polarity (e.g. negative pole) that is opposite to the first contact element. The contact elements can provide an electric power supply of the PTC heating elements.

The first PTC heating element and the second PTC heating element can be designed in the same type and/or identical. The first PTC heating element and the second PTC heating element can be connected to one another in an electrically conductive manner.

In an advantageous further development of the solution according to the invention it is provided that the additional heating device is designed in such a manner that a heat transfer from the additional heating device to the first PTC heating element and to the second heating element is formed by means of heat conduction and/or heat radiation and/or convection. Depending on the configuration of the additional heating device, the heat transfer can be optimised with respect to a heat transfer path or multiple heat transfer paths, in order to improve the coupling efficiency during the heat transfer to the PTC heating elements.

In a further advantageous embodiment of the solution according to the invention it is provided that the additional heating device comprises at least one additional heating element. The additional heating element can be designed as electric additional heating element, in particular as an electric non-self-regulating additional heating element. The additional heating element can be designed as electrical resistance heating element. Electric power, which is supplied to the additional heating element, can be converted by the additional heating element into heating power. Non-self-regulating means that for a regulation and/or control of the heating power of the additional heating element an additional regulation and/or control, in particular regulating circuit is required. The regulation and/or control of the heating power of the additional element can take place for example by means of pulse width modulation of the supplied electric power.

The additional heating device can comprise multiple additional heating elements, in particular multiple separate and/or spaced-apart additional heating elements. The multiple additional heating elements can for example be electrically conductively connected to one another, in particular connected in series or parallel.

The additional heating element is arranged between the first PTC heating element and the second PTC heating element, wherein the additional heating element with respect to the first PTC heating element and the second PTC heating element is electrically insulated. The additional heating element is heat-transferringly coupled to the first PTC heating element and the second PTC heating element, in particular heat-transferringly coupled by means of heat conduction and/or heat radiation and/or convection.

The electric additional heating element can be thermally but not electrically coupled to the PTC heating elements. The electric additional heating element can have no direct thermal contact with the medium (fluid, air, cooling water) to be heated. The electric additional heating element can be arranged and/or designed free of contact with the medium (fluid, air, cooling water) to be heated.

With respect to an axial axis, the additional heating element can be arranged between the first PTC heating element and the second PTC heating element.

With respect to an axial axis, the additional heating element can be arranged spaced apart from the first PTC heating element and spaced apart from the second PTC heating element.

At least one additional heating element can be designed as induction heating element.

In an advantageous further development of the solution according to the invention it is provided that the additional heating device comprises at least one contacting section, wherein the contacting section is arranged between the first PTC heating element and the second PTC heating element, wherein the contacting section forms an electrically conductive connection between the first PTC heating element and the second PTC heating element.

The additional heating device can form multiple contacting sections that are spaced apart from one another and/or separate contacting sections. At least one contacting section penetrates the additional heating device, in particular with respect to the axial axis. At least one contacting section or multiple contact sections can be arranged with respect to the axial axis between the first PTC heating element and the second PTC heating element. It can be provided that at least one additional heating element of the additional heating device can be arranged encapsulated in a contact section.

At least one contacting section and/or multiple contacting sections can be formed from an electrically conductive material.

By way of at least one contacting section, at least one low-ohmic electrical path between the two PTC heating elements can be formed.

In a further advantageous embodiment of the solution according to the invention it is provided that the additional heating element is electrically insulated with respect to the contacting section. The additional heating element can be electrically insulated with respect to the PTC heating elements. Thus, an electrically conductive connection between the additional heating element and the contacting section and/or between the additional heating element and the PTC heating elements can be prevented. It can be provided that the additional heating element, via an insulating section that provides an electrical insulation, is electrically decoupled relative to the contacting section and/or the PTC heating elements, so that the formation of an electrically conductive connection is prevented.

The electric additional heating element can be electrically decoupled from the PTC heating elements and from the contacting section, but be thermally connected with the electrically conductive material, in particular the PTC heating elements and the contacting section so that an adequate heat conduction is ensured and additionally a low-ohmic electrical path between the two PTC heating elements is formed.

In an advantageous further development of the solution according to the invention it is provided that the additional heating device touchingly lies against a surface section of the first PTC heating element at least in sections, and that the additional heating device touchingly lies against a surface section of the second PTC heating element at least in sections.

It can be provided that at least one contacting section or multiple contacting sections touchingly lies/lie against the surface section of the first PTC heating element at least in sections and against the surface section of the second PTC heating element at least in sections.

It can be provided that at least one insulating section or multiple insulating sections touchingly lies/lie against the surface section of the first PTC heating element at least in sections and against the surface section of the second PTC heating element at least in sections.

In a further advantageous embodiment of the solution according to the invention it is provided that the additional heating device comprises at least one additional heating element which forms an electrical resistance profile as a function of its operating temperature, in which the electrical resistance of the additional heating element substantially increases linearly with rising operating temperature of the additional heating element, and/or that the additional heating device comprises at least one additional heating element in the form of a resistance heating element, in particular of a thick film heating element and/or of a wire heating element and/or of a heating coil and/or of a heating plate. The use of such an additional heating element in the form of a resistance heating element makes possible a simple and cost-effective adjustment of the operating temperature of the PTC heating elements. A heating plate can form a resistance heating plate and/or a resistance track.

Furthermore, the invention relates to a heating element register for a heating device of a vehicle, wherein the heating element register comprises multiple heating element assemblies according to the invention. Combining multiple heating element assemblies into a heating element register makes possible a simple and modular construction, wherein for example by way of the number of the heating element registers the total heating power of the heating device can be determined in a simple manner.

In a further advantageous embodiment of the solution according to the invention it is provided that multiple or all heating element assemblies comprise a common additional heating device, or that at least one heating element assembly comprises a separate additional heating device. When using a common additional heating device for multiple heating element assemblies, an installation space-optimised and/or cost-optimised configuration of the heating element register can be provided.

Furthermore, the invention relates to a heating device for a vehicle, wherein the heating device comprises at least one heating element assembly according to the invention and/or multiple heating element register/s according to the invention.

The heating device can be designed as electric heating device having a multiplicity of heating bars or heating element registers for heating a fluid with a multiplicity of PTC heating elements, wherein the heating elements are electrically contacted by means of contact elements in order to provide an electric power supply. On an electric additional heating device, the PTC heating elements can be thermally contacted with at least one additional heating element, wherein the PTC heating elements can be electrically insulated with respect to the additional heating element. The electric additional heating device can control and/or regulate the efficiency of the PTC heating elements via the heat supply.

The vehicle can be a trackless road vehicle. In particular, the vehicle can be an electrically driven vehicle, in particular an electric vehicle and/or a hybrid vehicle.

Furthermore, the invention relates to a method for operating a heating device, in particular a heating device according to the invention, in which prior to supplying at least one PTC heating element with an electric operating voltage an operating temperature adjustment of the PTC heating element by means of an additional heating device takes place.

It can be provided that prior to a supplying of all PTC heating elements with an electric operating voltage an operating temperature adjustment of all PTC heating elements by means of at least one additional heating device or multiple additional heating devices takes place.

The electric operating voltage, with which the PTC heating elements are supplied, can be in the range from 10 V to 1,000 V, in particular in the range from 12 V to 800 V. This electric operating voltage can be in particular 12 V or 400 V or 800 V.

An operating temperature adjustment of at least one PTC heating element by means of an additional heating device can be designed in such a manner that for example an electric additional heating element, in particular an electrical resistance heating element, of the additional heating device is supplied with electric power in order to carry out a heating of the PTC heating element, until the PTC heating element has an operating temperature above the limit temperature, i.e. in the PTC operating range. Until the PTC heating element has reached an operating temperature above the limit temperature, the PTC heating element is not supplied with electric operating voltage.

Through the heating of the PTC heating element by means of the additional heating device, the PTC heating elements, prior to being supplied with the operating voltage, can be transferred into the PTC operating range so that an occurrence of a peak load, in particular a peak current load, at the limit temperature can be avoided since at the time and/or time interval, in which the operating temperature of the PTC heating elements corresponds to the limit temperature, no electric current flows through the PTC heating elements.

By way of this method, a simple possibility for reducing electric current peaks is provided, so that altogether a reduction of vehicle electrical system loads in particular a reduction of the load on electronic power assemblies and components can be achieved in the vehicle. Furthermore, an improvement of the dynamics of the PTC heater and a cost reduction through improved efficiency can be provided, since for example more cost-effective components can be employed.

In a further advantageous embodiment of the solution according to the invention it is provided that the additional heating device during the operating temperature adjustment increases the operating temperature of the PTC heating element up to a predefined set-point operating temperature by means of a heat supply, and/or that the additional heating device, after a predefined set-point operating temperature of the PTC heating element has been reached, discontinues the heat supply to the PTC heating element, and/or that, after a predefined set-point operating temperature of the PTC heating element has been reached, the same is supplied with an electric operating voltage.

The set-point operating voltage of the PTC heating element can be in the PTC operating range above the limit temperature.

The electric operating voltage, with which the PTC heating element is supplied, can be in the range from 10 V to 1,000 V, in particular in the range from 12V to 800 V. In Particular, this electric operating voltage can amount to 12 V or 400 V or 800 V.

In a further advantageous embodiment of the solution according to the invention it is provided that the method is designed as computer-implemented method.

In a further advantageous embodiment of a heating device for a vehicle it is provided that the heating device comprises a control device, which is designed and/or programmed for carrying out the method according to the invention. The heating device can comprise means for establishing the operating temperature of the PTC heating elements, which can be communicatingly connected to the control device.

Furthermore, the invention relates to a vehicle having a heating device according to the invention.

The vehicle can be a trackless road vehicle. In particular, the vehicle can be an electrically driven vehicle, in particular an electric vehicle and/or a hybrid vehicle.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically

FIG. 1 shows a resistance characteristic curve of a PTC heating element,

FIG. 2 shows a heating element assembly according to the invention,

FIG. 3 shows a further heating element assembly according to the invention,

FIG. 4 shows a plan view of a heating element assembly according to the invention,

FIG. 5 shows a vehicle having a heating device according to the invention.

### DETAILED DESCRIPTION

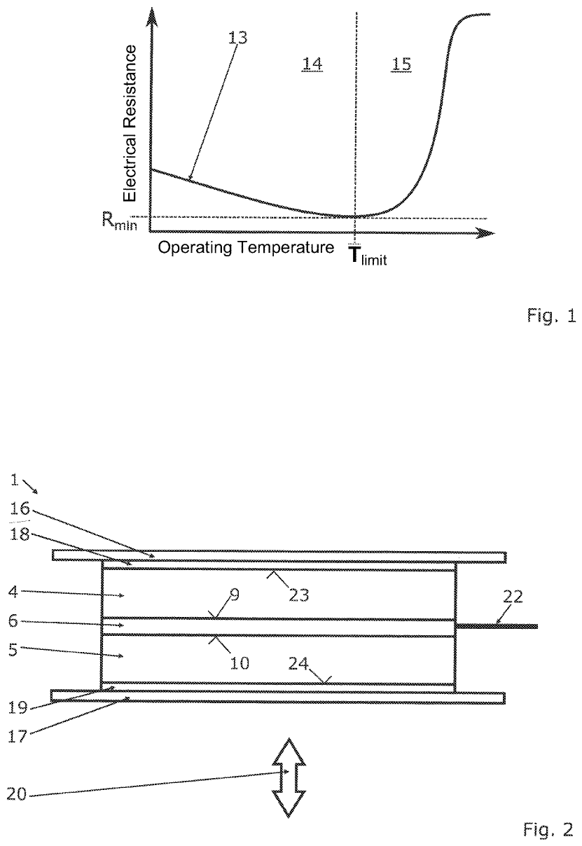

In FIG. 1, the electrical resistance of a PTC heating element 4, 5 of FIG. 2 is shown as a function of the operating temperature of the PTC heating element 4, 5 by a resistance characteristic curve 13. The electrical resistance is shown with respect to a logarithmic scale. The resistance characteristic curve 13 shows altogether a non-linear relationship between the electrical resistance of the PTC heating element 4, 5 and the operating temperature of the PTC heating element 4, 5.

The PTC heating element 4, 5 has an NTC operating range 14 and a PTC operating range 15, wherein the electrical resistance of the PTC heating element 4, 5 in the NTC operating range 14 decreases with increasing operating temperature of the PTC heating element 4, 5, while the electrical resistance of the PTC heating element 4, 5 in the PTC operating range 15 non-linearly increases with increasing operating temperature of the PTC heating element 4, 5.

The transition point from the NTC operating range 14 to the PTC operating range 15 of the PTC heating element 4, 5 can be defined by the limit temperature Tlimit, at which the PTC heating element 4, 5 has a minimal electrical resistance Rmin.

In this transition point at a limit temperature Tlimit, the PTC heating element 4, 5 would form, at a predefined operating voltage, a maximum electric current flow. A particularly high current flow occurs in particular at higher operating voltages such as for example above 400 V.

In order to limit this maximum current flow and reduce electrical peak load, the heating element assembly 1 shown in FIG. 2 comprises an additional heating device 6, which, with respect to an axial axis 20, is arranged between a first PTC heating element 4 and a second PTC heating element 5 which with respect to the axial axis 20 is spaced apart from the former. Prior to supplying the PTC heating elements 4, 5 with the electric operating voltage, an operating temperature adjustment of the PTC heating elements 4, 5 by means of the additional heating device 6 is carried out.

During the operating temperature adjustment, the additional heating device increases the operating temperature of the PTC heating elements 4, 5 up to a predefined set-point operating temperature by means of heat supply, wherein the set-point temperature is greater than the limit temperature Tlimit. To this end, the additional heating device can convert for example electric power into heating power.

After the predefined set-point operating temperature of the PTC heating elements 4, 5 has been reached, the additional heating device can discontinue the heat supply to the PTC heating elements 4, 5. The operating temperature of the heating elements 4, 5 can take place for example by way of temperature sensors which are not shown. Following the reaching of the predefined set-point operating temperature of the PTC heating elements 4, 5, these are supplied with the electric operating voltage and operated in the PTC operating range 15.

The first PTC heating element 4 and the second heating element 5 can define a heating element pair. In an embodiment which is not shown, it can be provided that an additional heating device 6 is assigned to multiple heating element pairs. The multiple heating element pairs can be arranged spaced apart from one another, in particular, the heating element pairs can be arranged, with respect to an axis transversely and/or perpendicularly to the axial axis 20, spaced apart from one another. In such an embodiment which is not shown, the additional heating device 6 can be arranged at least in sections between the first PTC heating element 4 and the second PTC heating element 5 of each heating element pair.

The first PTC heating element 4 and the second PTC heating element 5 are arranged spaced apart from one another with respect to the axial axis 20, wherein the additional heating device 6 is arranged, with respect to the axial axis 20, between the first PTC heating element 4 and the second PTC heating element 5 at least in sections.

The first PTC heating element 4 comprises a contact surface 23 which faces away from the additional heating device 6. The first PTC heating element 4 comprises a surface section 9 which faces the additional heating device 6. The contact surface 23 and the surface section 9 form substantially planar and/or flat surfaces, wherein the contact surface 23 and the surface section 9 are orientated substantially parallel to one another and are formed spaced apart from one another with respect to the axial axis 20. The axial axis 20 is orientated substantially parallel to the surface normal vector of the contact surface 23 and of the surface section 9 which is not shown.

The second PTC heating element 5 comprises a contact surface 24 which faces away from the additional heating device 6. The second PTC heating element 5 comprises a surface section 10 which faces the additional heating device 6. The contact surface 24 and the surface section 10 form substantially planar and/or flat surfaces, wherein the contact surface 24 and the surface section 10 are orientated substantially parallel to one another and formed spaced apart from one another with respect to the axial axis 20. The axial axis 20 is orientated substantially parallel to the surface normal vector of the contact surface 24 and of the surface section 10 which is not shown.

The additional heating device 6 touchingly lies against the surface section 9 of the first PTC heating element 4 at least in sections. The additional heating device 6 touchingly lies against the surface section 10 of the first PTC heating element 5 at least in sections.

The first PTC heating element 4, the second PTC heating element 5 and the additional heating device 6 are arranged, with respect to the axial axis 20, between two support bodies 16, 17 that are spaced apart from one another, wherein the support bodies 16, 17 each have a side facing away from the PTC heating elements 4, 5, past which a fluid, which is to be heated by the PCT heating elements 4, 5, which is not shown, can flow. The first PTC heating element 4, the second PTC heating element 5 and the additional heating device 6 can be encapsulated by the support bodies 16, 17 relative to the fluid in a fluid-tight manner.

Between the respective contact surface 23, 24 of the PTC heating elements 4, 5 and the support body 16, 17 located opposite the contact surface 23, 24 of the PTC heating element 4, 5 a contact element 18, 19 each can be formed. The contact elements 18, 19 are each electrically conductively connected to the respective PTC heating element 4, 5 and formed electrically insulated relative to the respective support body 16, 17. Thus, a first contact element 18 is arranged touchingly lying against the contact surface 23 of the first PTC heating element 4, wherein a second contact element 19 is arranged touchingly lying against the contact surface 24 of the second PTC heating element 5. The first contact element 18 can have a first electrical polarity (e.g. positive pole) and thus form a first electrical pole, wherein the second contact element 19 can have a polarity that is opposite to that of the first contact element (e.g. negative pole). The contact elements 18, 19 can be connected to an electric energy source of a vehicle which is not shown and provide an electric power supply of the PTC heating elements 4, 5.

The first PTC heating element 4 and the second PTC heating element 5 are electrically conductively connected to one another via the additional heating device 6.

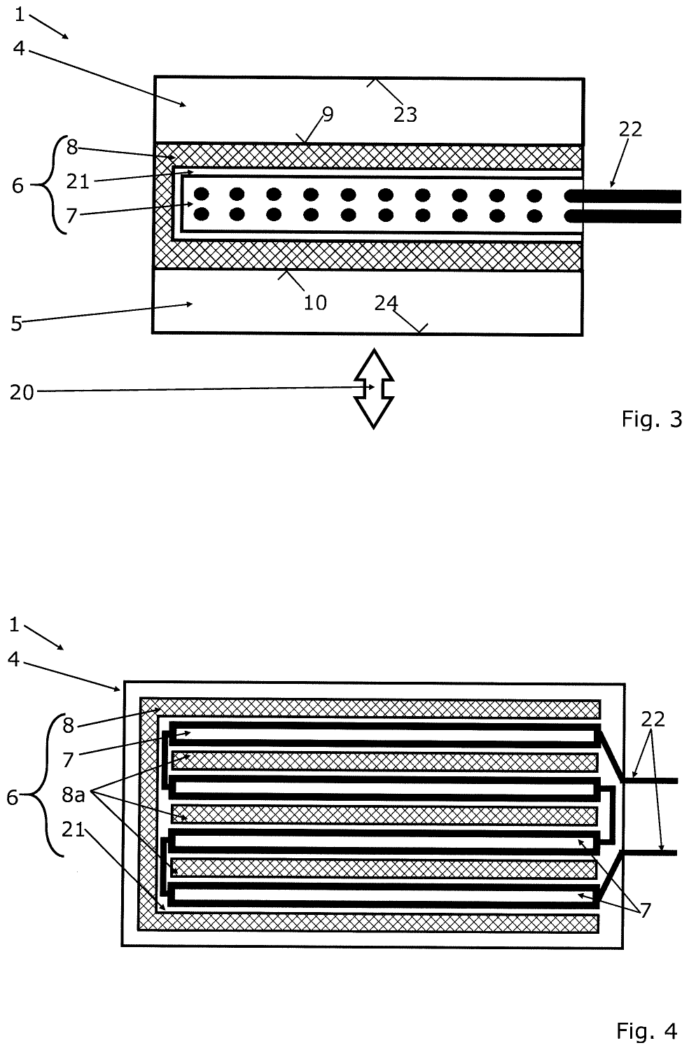

FIG. 3 shows an embodiment of a heating element assembly 1 according to the invention, wherein the additional heating device 6 is shown in more detail.

The additional heating device 6 comprises at least one additional heating element 7. This additional heating element 7 is exemplarily formed as heating wire coil in FIG. 3, which is supplied with electric power via power supply contacts 22. With respect to the axial axis 20, the additional heating element 7 is arranged between the first PTC heating element 4 and the second PTC heating element 5. The additional heating device 6 comprises at least one contacting section 8 which is arranged between the first PTC heating element 4 and the second PTC heating element 5, wherein the contacting section 8 forms an electrically conductive connection between the first PTC heating element and the second PTC heating element 5. The additional heating element 7 is electrically insulated with respect to the first PTC heating element 4 and the second PTC heating element 5 and with respect to the contacting section 8. The electrical insulation of the additional heating element 7 is formed by an insulating section 21. The insulating section 21 can be formed of an electrically insulating material.

The additional heating element 7 is heat-transferringly coupled to the contact section 8 and to the first PTC heating element 4 and the second PTC heating element 5, in particular heat-transferringly coupled by means of heat conduction and/or heat radiation and/or convection.

FIG. 4 shows a plan view transversely and/or perpendicularly to the axial axis 20 onto an embodiment of a heating element assembly 1 according to the invention, wherein the additional heating device 6 is shown in more detail.

The additional heating device 6 comprises a contacting section 8 which in the plan view is formed U-shaped. Furthermore, multiple contacting sections 8a that are spaced apart from one another are formed, which in the plan view are arranged within the contacting section 8 formed U-shaped. Between the contacting sections 8 and 8a multiple additional heating elements 7 are formed as planar resistance heating elements, which are electrically connected in series and are supplied with electric power via power supply contacts 22. The additional heating elements 7 and the contacting sections 8 and 8a are electrically insulated from one another via an insulating section 20 or multiple insulating sections 20.

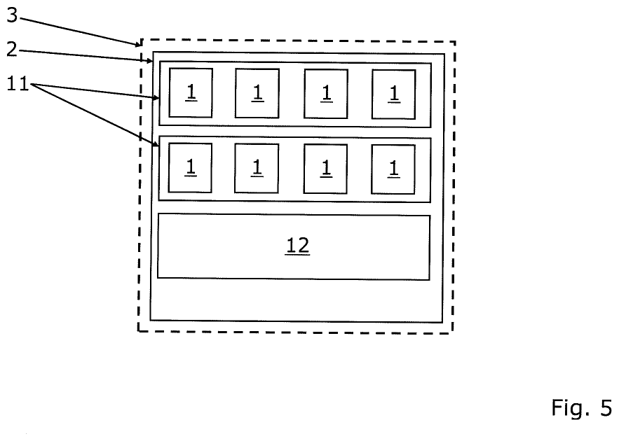

FIG. 5 shows schematically a vehicle 3 having a heating device 2, wherein the heating device 2 comprises multiple heating element registers 11, which in turn comprise multiple heating element assemblies 1. Furthermore, the heating device 2 comprises a control device 12 which is designed and/or programmed for carrying out operating temperature adjustment of the PTC heating elements 4, 5.

1. A heating element assembly for a heating device of a vehicle, comprising:
at least one first PTC heating element configured to heat a fluid;
at least one second PTC heating element configured to heat the fluid;
at least one additional heating device configured to heat the at least one first PTC heating element and the at least one second PTC heating element;
wherein the at least one first PTC heating element and the at least one second PTC heating element are arranged spaced apart from one another; and
wherein the at least one additional heating device is arranged, at least in sections, between the at least one first PTC heating element and the at least one second PTC heating element.

2. The heating element assembly according to claim 1, wherein the at least one additional heating device is configured to transfer heat to the at least one first PTC heating element and to the at least one second PTC heating element via at least one of heat conduction, heat radiation, and convection.

3. The heating element assembly according to claim 1, wherein:
the at least one additional heating device includes an additional heating element;
the additional heating element is arranged between the at least one first PTC heating element and the at least one second PTC heating element;
the additional heating element is electrically insulated with respect to the at least one first PTC heating element and the at least one second PTC heating element; and
the additional heating element is heat-transferringly coupled to the at least one first PTC heating element and the at least one second PTC heating element.

4. The heating element assembly according to claim 1, wherein:
the at least one additional heating device includes at least one contacting section;
the at least one contacting section is arranged between the at least one first PTC heating element and the at least one second PTC heating element; and
the at least one contacting section forms an electrically conductive connection between the at least one first PTC heating element and the at least one second PTC heating element.

5. The heating element assembly according to claim 4, wherein:
the at least one additional heating device includes an additional heating element and
the additional heating element is electrically insulated with respect to the at least one contacting section.

6. The heating element assembly according to claim 1, wherein:
the at least one additional heating device, at least in sections, touchingly abuts against a surface section of the at least one first PTC heating element; and
the at least one additional heating device, at least in sections, touchingly abuts against a surface section of the at least one second PTC heating element.

7. The heating element assembly according to claim 1, wherein:
the at least one additional heating device includes at least one additional heating element; and
the at least one additional heating element has an electrical resistance curve in which an electrical resistance of the at least one additional heating element increases substantially linearly as an operating temperature of the at least one additional heating element rises.

8. A heating element register for a heating device of a vehicle, comprising a plurality of heating element assemblies according to claim 1.

9. The heating element register according to claim 8, wherein at least one of:
the at least one additional heating device of at least two of the plurality of heating assemblies is defined by a common additional heating device; and
the at least one additional heating device of at least one heating element assembly of the plurality of heating element assemblies is structured as a separate additional heating device.

10. A heating device for a vehicle, comprising at least one heating element assembly according to claim 1.

11. A method for operating a heating device including a heating element assembly, the heating element assembly including at least one first PTC heating element configured to heat a fluid, at least one second PTC heating element configured to heat the fluid, and at least one additional heating device configured to heat the at least one first PTC heating element and the at least one second PTC heating element, the at least one first PTC heating element and the at least one second PTC heating element arranged spaced apart from one another, and the at least one additional heating device arranged, at least in sections, between the at least one first PTC heating element and the at least one second PTC heating element, the method comprising:
supplying an electric operating voltage to at least one PTC heating element of the at least one first PTC heating element and the at least one second PTC heating element; and
prior to supplying the electric operating voltage to the at least one PTC heating element, adjusting an operating temperature of the at least one PTC heating element via the at least one additional heating device.

12. The method according to claim 11, wherein adjusting the operating temperature of the at least one PTC heating element includes increasing the operating temperature of the at least one PTC heating element to a predefined set-point operating temperature via providing a heat supply with the at least one additional heating device.

13. The method according to claim 11, wherein the method is a computer-implemented method.

14. A heating device for a vehicle, comprising a heating element assembly and a control device configured to carry out the method according to claim 11, the heating element assembly including:
at least one first PTC heating element configured to heat a fluid;
at least one second PTC heating element configured to heat the fluid;
at least one additional heating device configured to heat the at least one first PTC heating element and the at least one second PTC heating element
wherein the at least one first PTC heating element and the at least one second PTC heating element are arranged spaced apart from one another; and
wherein the at least one additional heating device is arranged, at least in sections, between the at least one first PTC heating element and the at least one second PTC heating element.

15. A vehicle, comprising the heating device according to claim 14.

16. The method according to claim 12, wherein adjusting the operating temperature of the at least one PTC heating element further includes discontinuing the providing of the heat supply to the at least one PTC heating element after the predefined set-point operating temperature of the at least one PTC heating element has been reached.

17. The method according to claim 12, wherein the electric operating voltage is supplied after the predefined set-point operating temperature of the at least one PTC heating element has been reached.

18. The heating element assembly according to claim 1, wherein the at least one additional heating device includes at least one additional heating element structured as a resistance heating element.

19. The heating element assembly according to claim 1, wherein the resistance heating element is structured as at least one of a thick film heating element, a wire heating element, a heating coil, and a heating plate.

20. The heating element assembly according to claim 3, wherein the additional heating element is heat-transferringly coupled to the at least one first PTC heating element and the at least one second PTC heating element via at least one of heat conduction, heat radiation, and convection.
